(19) United States
(12) Patent Application Publication
(10) Pub. No.: US 2009/0154892 A1
(43) Pub. Date: Jun. 18, 2009

(54) RECORDING AND REPRODUCTION APPARATUS AND METHODS, AND A STORING MEDIUM HAVING RECORDED THEREON COMPUTER PROGRAM TO PERFORM THE METHODS

(75) Inventor: Mineki Taoka, Yokohama (JP)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 12/327,983

(22) Filed: Dec. 4, 2008

(30) Foreign Application Priority Data
Dec. 14, 2007 (JP) 2007-323932

(51) Int. Cl. H04N 5/93

(52) U.S. Cl. 386/52

(57) ABSTRACT

Recording and reproduction apparatus and methods, and a computer program to execute the methods, capable of easily performing image processes on raw data for various image capturing modes. The recording apparatus includes an image processor for performing image processes into reproducible image data on raw data sequentially output from an imaging device in frames and generating processed image data in frames, an image capturing condition obtaining unit for obtaining image capturing conditions per frame, which are required for reading pixel data from the imaging device and are set when the processed image data is being recorded, and a storage medium recorder for sequentially recording the raw data in frames, the processed image data in frames, and the image capturing condition in frames to a storage medium per frame.

### CROSS-REFERENCE TO RELATED PATENT APPLICATION

This application claims the benefit of Japanese Patent Application No. 2007-323932, filed on Dec. 14, 2007, in the Japanese Intellectual Property Office, the entire content of which is incorporated herein by reference.

### BACKGROUND OF THE INVENTION

1. Field of the Invention

The present invention relates to recording and reproduction apparatus and methods, and a storing medium having recorded thereon computer program to perform the methods.

2. Description of the Related Art

Generally, an image capturing device capable of recording motion pictures, such as a video camera, camcorder, etc., performs predetermined image processing (image signal processing) on signals output from each of pixels of an imaging device such as a charge-coupled device (CCD), performs compression in a format such as the motion picture experts group (MPEG)-2, the motion joint photographic experts group (JPEG), etc., and records image data to a storage medium such as a flash memory, a hard disk drive (HDD), or a digital versatile disc (DVD). Image processing includes white balance control, exposure control, etc. Also, during a compression process, calculations for a pixel mixing process and a pixel cropping process in an imaging device are performed according to patterns (conditions) for reading data from the imaging device. Furthermore, the pattern for reading data depends on a configuration of the imaging device, and image capturing modes with respect to image capturing conditions of an image capturing device.

Generally, if the image capturing device includes a data reading pattern corresponding to an internal imaging device, the pixel mixing process or the pixel cropping process can be performed. Thus, when a compression process is performed within an image capturing device the compression process can be performed with a limited sized database. Meanwhile, to externally performing image signal processes by using software after outputting raw data, a data reading pattern depending on conditions, such as a configuration of an imaging device, is required. Thus, data reading patterns for various conditions should be prepared in advance.

However, it is difficult to prepare a plurality of data reading patterns corresponding to a plurality of imaging device in advance. Furthermore, if a new imaging device is employed, a data reading pattern corresponding to the new imaging device is needed. Furthermore, data reading patterns vary according to image capturing conditions of an image capturing device, and thus, a large database is required to perform image signal processes on raw data.

### SUMMARY OF THE INVENTION

The present invention provides recording and reproduction apparatus and methods for easily processing raw data in correspondence with various image capturing modes, and provides a storing medium having recorded thereon a computer program for executing the methods.

Accordingly, an embodiment of the present invention provides a recording apparatus comprising an image processor for processing an image into reproducible image data on raw data sequentially output from an imaging device in frames and generating reproducibly processed image data in frames, an image capturing condition obtaining unit for obtaining image capturing conditions per frame, which are required for reading pixel data from the imaging device and are set when the processed image data is being recorded, and a storage medium recorder for sequentially recording the raw data in frames, the processed image data in frames, and the image capturing condition in frames to a storage medium per frame. The image capturing condition may be a condition regarding pixel mixing process or pixel cropping process on each of pixels when pixel data is being read from the imaging device.

Another embodiment of the present invention provides a reproduction apparatus comprising a data reader for reading out at least one of each of raw data, each of processed image data, and each of image capturing condition from a storage medium having recorded thereon the raw data in frames, with the reproducibly processed image data being in frames obtained by performing image processes into reproducible image data on the raw data, and the image capturing conditions per frame according to an image capturing mode being set when the processed image data is being recorded; and an image processor performing an image process by reading each pixel data from an imaging device according to the read out image capturing condition when the raw data is sequentially reproduced per frame. The image reading condition may be a condition regarding pixel mixing process or pixel cropping process on each of pixels when pixel data is being read from the imaging device.

A further embodiment of the present invention provides a recording method comprising performing image processes into reproducible image data on raw data sequentially output from an imaging device in frames and generating processed image data in frames, obtaining image capturing conditions per frame, which are required for reading pixel data from the imaging device and are set when the processed image data is being recorded, and sequentially recording the raw data in frames, the processed image data in frames, and the image capturing conditions in frames to a storage medium per frame.

Another embodiment of the present invention provides a reproducing method comprising reading out at least one of each of raw data, each of processed image data, and each of image capturing condition from a storage medium having recorded thereon the raw data in frames, with the processed image data being in frames obtained by performing image processes into reproducible image data on the raw data, and the image capturing condition per frame according to an image capturing mode being set when the processed image data is being recorded. The method further comprises performing an image process by reading each pixel data from an imaging device according to the read out image capturing condition.

Still a further embodiment of the present invention provides a storage medium having recorded thereon a computer program for executing a method, the method comprising performing image processes into reproducible image data on raw data, sequentially output from an imaging device in frames and generating processed image data in frames, obtaining image capturing conditions per frame, which are required for reading pixel data from the imaging device and are set when the processed image data is being recorded, and sequentially recording the raw data in frames, the processed image data in frames, and the image capturing conditions in frames to a storage medium per frame.

Another embodiment of the present invention provides a storage medium having recorded thereon a computer program for executing a method, the method comprising reading out at least one of each of raw data, each of processed image data, and each of image capturing condition from a storage medium having recorded thereon the raw data in frames, with the processed image data in frames being obtained by performing image processes into reproducible image data on the raw data, and the image capturing condition per frame according to an image capturing mode being set when the processed image data is being recorded, and performing an image process by reading each pixel data from an imaging device according to the read out image capturing condition.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating an example of a configuration of a motion picture recording apparatus according to an embodiment of the present invention;

FIGS. 2(a) and 2(b) are schematic diagrams illustrating an example of a recording format in which the motion picture recording apparatus records a motion picture data to a storage medium, according to an embodiment of the present invention;

FIGS. 3(a)-3(c) are schematic diagrams of an example of an image capturing surface of an imaging device according to an embodiment of a present invention; and

FIG. 4 is a block diagram illustrating an example of a configuration of a motion picture reproduction apparatus according to an embodiment of the present invention.

### DETAILED DESCRIPTION OF THE EMBODIMENTS

Exemplary embodiments of the present invention will now be described more fully with reference to the accompanying drawings, in which like reference numerals in the drawings denote like elements.

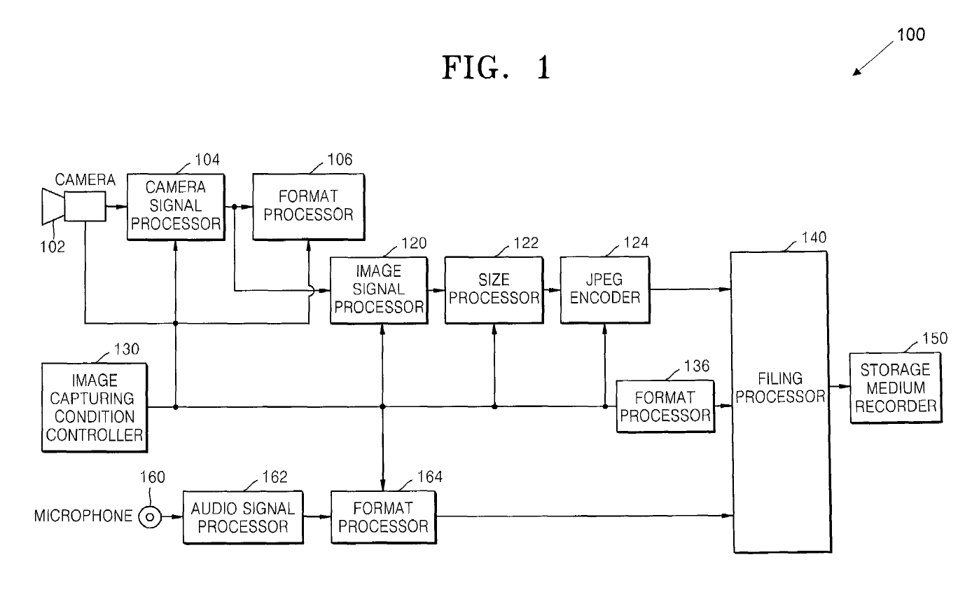

FIG. 1 is a block diagram illustrating the configuration of a motion picture recording apparatus 100 according to an embodiment of the present invention. As shown in FIG. 1, the motion picture recording apparatus 100 includes a camera 102, a camera signal processor 104, a format processor 110, an image signal processor 120, a size processor 122, a joint photographic experts group (JPEG) encoder 124, an image capturing condition controller 130, a format processor 136, a filing processor 140, a storage medium recorder 150, a microphone 160, an audio signal processor 162, and a format processor 164.

Motion picture data per frame output from an imaging device, such as a charge-coupled device (CCD), a complementary metal oxide semiconductor (CMOS), etc., of the camera 102 is input to the camera signal processor 104. The camera signal processor 104 includes an analog-to-digital (AD) converter converting an input analog motion picture data to a digital motion picture signal. A digital image signal output from the camera signal processor 104 is transmitted to both the format processor 110 and the image signal processor 120.

The format processor 110 rearranges digital-converted red (R), green (G), and blue (B) signals according to a pixel arrangement (i.e., the Bayer arrangement, triple CCD, etc.) of imaging device. Also, the format processor 110 performs reversible compression on motion picture data in a frame Reversible compression method enable recording and reproducing image data without degradation in image quality, etc. An example of a reversible compression method is an entropy encoding using Huffman codes. The reversible compression is not limited to a reversible compression in the strict meaning. Accordingly, the format processor 110 does not perform compression, whereby image quality is lost, in order to maintain image quality in raw data. Also, since the size of raw data is very large, the format processor 110 eliminates most of unnecessary part from the raw data. Motion picture data formatted by the format processor 110 is input to the filing processor 140 as raw data.

The image signal processor 120 performs image signal processes on input image data, wherein the image signal processes including a white balance process, a data interpolation process according to the Bayer arrangement, noise elimination, brightness and color correction, etc. Data processed by the image signal processor 120 is transmitted to the size processor 122. In the image signal processor 120, image signal processes are performed by changing a resolution, frame rate, and quality of the image according to an image capturing condition controlled by the image capturing condition controller 130.

The size processor 122 performs a process to reduce or to enlarge the size of motion picture data. Data output from the size processor 122 is transmitted to the JPEG encoder 124. Furthermore, as an occasion demands, the size processor 122 performs the process of reducing the size of motion picture data according to the screen size of display devices such as a electronic view finder (EVF) (not shown), a liquid crystal display (LCD) (not shown), etc. Data output from the size processor 122 is transmitted to a display device such as an EVF or a LCD and is displayed on the screen of the same. Thus, a user can recognized an image captured by the camera 102 in real time.

The JPEG encoder 124 performs JPEG compression encoding process on input data and transmitted compressed image data (processed image data) to the filing processor 140. The image capturing condition controller 130 controls conditions under which the motion picture recording apparatus 100 captures an image. Examples of image capturing conditions include conditions regarding an imaging device, such as the number of pixels of an imaging device, pitch of pixels, etc., an image resolution, a frame rate, or the quality of an image. According to such image capturing conditions, conditions for reading each pixel data from an imaging device vary. The image capturing condition controller 130 provides information pertaining to image capturing conditions to the camera 102, the camera signal processor 104, the format processor 110, the image signal processor 120, the size processor 122, the JPEG encoder 124, and the format processor 164. Each of these components sets the image capturing condition according to the instruction. Then, the image capturing condition controller 130 transmits image capturing condition data to the format processor 136.

The format processor 136 performs a format process on the image capturing condition data, and transmits the formatted data to the filing processor 140. The format processor 136 is an example of an image capturing condition obtaining unit and is required for reading each pixel data from an imaging device. The format processor 136 obtains image capturing conditions per frame, which are set when processed image data is recorded. The image capturing conditions set when the processed image data is recorded refer, for example, to conditions for pixel mixing process or pixel cropping process for each pixel when each pixel data is being read from an imaging device.

The filing processor 140 temporarily stores raw data transmitted from the format processor 110, compressed image data compressed in the JPEG encoder 124, or image capturing condition data transmitted from the format processor 132. The raw data transmitted from the format processor 110, the compressed image data compressed in the JPEG encoder 124, and the image capturing condition data transmitted from the format processor 132, which are stored in the filing processor 140, are transmitted to the storage medium recorder 150 and are recorded to a storage medium according to a recording format of the storage medium. Examples of the storage medium include optical recording media (CD, DVDs, etc.), magneto-optical disks, magnetic disks, semiconductor memory devices, etc.

Furthermore, the microphone 160 obtains voice of the subject of an image when the camera 102 captures a motion picture and transmits the voice to the audio signal processor 162. The audio signal processor 162 includes an analog/digital (AD) converter converting input analog voice signals to digital voice signals. The digital voice signals output from the audio signal processor 162 are transmitted to the format processor 164. The format processor 164 formats the voice data by using compression methods such as a non-compressive pulse code modulation (PCM) method, an adaptive differential PCM (ADPCM) method, an advanced audio coding (AAC) method, an audio codec 3 (AC3) method, an motion picture experts group 1 audio layer 3 (MP3) method, etc. The voice data formatted by the format processor 164 is input to the filing processor 140. The filing processor temporarily stores the voice data.

Furthermore, although not shown, the motion picture recording apparatus 100 may include a host CPU. The host CPU controls data transmission from the filing processor 140 to the storage medium recorder 150 and data recording of the storage medium recorder 150 to a storage medium. The host CPU transmits compressed image data, raw data, and image capturing condition data, which are stored in the filing processor 140, to the storage medium recorder 150 per predetermined quantity (i.e. data quantity of one frame) and controls the filing processor 140, the audio data, and the storage medium recorder 150 such that the transmitted data are sequentially recorded to a storage medium. The host CPU records compressed image data, raw data, audio data, and image capturing condition data to a storage medium in a predetermined sequence.

In addition, processes in the motion picture recording apparatus 100 can be performed either by hardware or software. In the motion picture recording apparatus 100 according to the current embodiment, digital image data, which is output from the imaging device of the camera 102 and converted from analog to digital, is transmitted to the format processor 110, and raw data is recorded to a storage medium. Therefore, high-quality raw data is recorded to a storage medium, and images having higher quality as compared to compressed image data can be reproduced by reading and displaying the raw data.

Also, since the size of raw data is very large, images cannot be displayed on a display device such as an EVF or a LCD in real time by using raw data. Furthermore, a compression process such as JPEG compression cannot be performed directly on raw data. In the motion picture recording apparatus 100 according to this embodiment, since the image signal process, the size reducing process, and the compression process are performed together with raw data recording, images can be displayed on a display device such as an EVF or a LCD in real time while the images are being captured. Thus, a user can capture images while monitoring the displayed images. Furthermore, since compressed image data is recorded to a storage medium together with raw data, operations such as image browsing, thumbnail image displaying, etc., can be performed by using the compressed image data. Therefore, an important part of images can be reproduced in high quality by using raw data, whereas a relatively less important part of images can be reproduced in simplified form by quickly reading compressed image data.

Furthermore, the motion picture recording apparatus 100 according to the current embodiment stores raw data intact and files image capturing condition data, necessary for changing conditions for reading each pixel data from an imaging device, together with raw data. Since the image capturing condition data is recorded to a storage medium together with raw data, an image signal process on raw data can be performed by reading the image capturing condition data during a reproduction. As a result, an appropriate image process can be performed according to the raw data even if a plurality of images are taken under different image capturing conditions and conditions for reading each of pixels from the image sensor are different from each other.

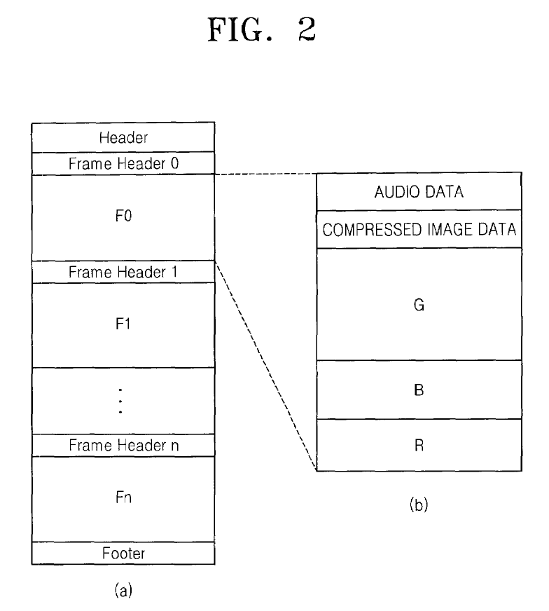

Next, a recording format at the storage medium will be described. FIGS. 2(a) and 2(b) are schematic diagrams illustrating an example of a recording format in which the motion picture recording apparatus 100 records data to a storage medium, according to an embodiment of the present invention. For example, if only one Bayer imaging device is used, data is output in a pixel sequence of the Bayer arrangement of R:G:B=1:2:1. To record the data in the Bayer arrangement without loss of image quality, the data is rearranged in a sequence of RGB by the format processor 110 and the rearranged data is recorded to a storage medium without performing a compression process, which degrades image quality, in the motion picture recording apparatus 100.

FIG. 2(a) indicates a single motion picture file between the start of image recording (record start) and the end of image recording (record end). Furthermore, FIG. 2(b) indicates data of one frame in recorded data shown in FIG. 2(a).

RGB data according to the Bayer arrangement is rearranged by the format processor 110 and is recorded to a data region of a storage medium. Furthermore, compressed image data encoded by the JPEG encoder 124 and audio data formatted in a format processor 164 are also recorded to the data region. As shown in the section (a) of FIG. 2, a header is recorded to a first region of a recording format. General data including date on which an image is captured, information on an imaging device of the camera 102, a set name of the motion picture recording apparatus 100, the number of audio channels, the number of bits, information on a recording format of a storage medium, spec data of a lens of the camera 102, etc., are recorded to the header. After the header, data is recorded per frame of images.

Data per frame includes frame headers Frame Header 0 through Frame Header n and data per frame F0 through Fn. As shown in the section (b) of FIG. 2, data per frame are recorded repeatedly per frame in a sequence of audio data Audio, compressed image data Compressed Image, and RAW data G, B, and R. Then, a footer is recorded following to data of final frame Fn.

For example, the sizes of audio data, compressed image data, and RAW data of each frame are recorded to a frame header of each of the frames. Furthermore, image capturing condition data for each of the frames are recorded to the frame headers.

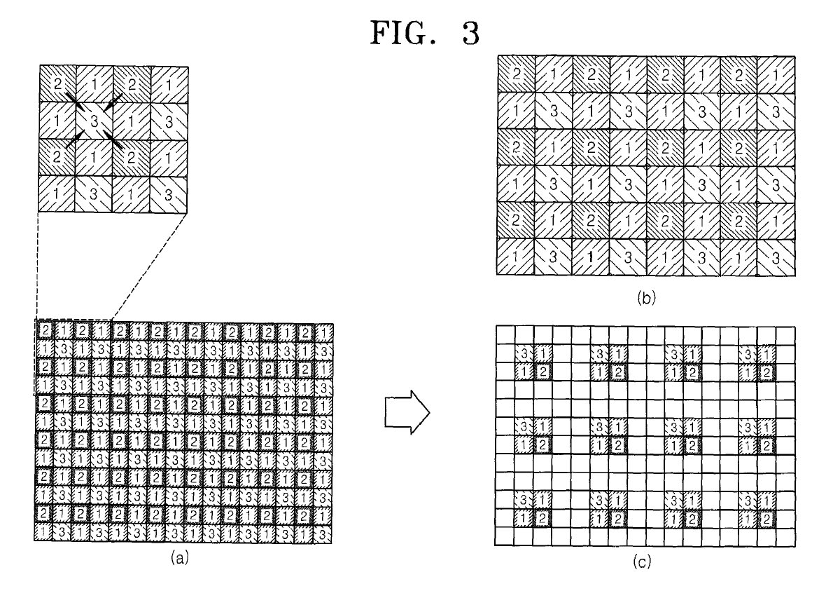

Next, an example of reading out pixels from an imaging device and mixing the pixels will be described in reference with FIGS. 3(a)-3(c). FIGS. 3(a)-3(c) are schematic diagrams of an image capturing surface of an imaging device according to an embodiment of the present invention.

Once image capturing conditions for each of frames recorded in a frame header are read out, configurations of an imaging device or an image capturing mode of the motion picture recording apparatus 100 can be known. Thus, reading pixels from the imaging device can be performed according to RAW data. The reading process may be pixel mixing process or pixel cropping process, for example.

A pixel mixing process performed in case of imaging device which has Bayer arrangement as shown in FIG. 3(a) will be described below. In case of performing pixel mixing by using two vertical pixels and two horizontal pixels, data is mixed from four diagonally adjacent pixels, as shown in FIG. 3(a). As a result, as shown in FIG. 3(b), output data resembles data in the Bayer arrangement with half vertical resolution and half horizontal resolution. However, the phase of pixels actually added becomes as shown in FIG. 3(c), and thus the spatial frequency is not necessarily reduced to half vertically and horizontally due to the pixel mixing.

However, data obtained without the information about the pixel mixing process only resembles the pattern shown in FIG. 3(b). Thus, image signal processes are performed on the assumption that the pattern shown in FIG. 3(b) is the pattern of the output data. The peak of the spatial frequency of the cropped data is close to f/2. However, the cropped data has the same resolution as the original data. Thus, distortion appears repeatedly in the cropped data.

Meanwhile, appropriate image signal processes can be performed by reading conditions regarding the pixel mixing process. The conditions regarding the pixel mixing process refer to conditions indicating which parts of pixel data from an imaging device are mixed. Furthermore, the reading process is not limited to the pixel mixing process, and thus the reading process may also be performed with respect to the pixel cropping process. The conditions for the pixel cropping process refer to conditions indicating which part of pixel data are cropped from an imaging device. In other word, the conditions for the pixel cropping process refer to conditions indicating which part of pixel data are excluded and which part of pixel data are extracted from an image sensor.

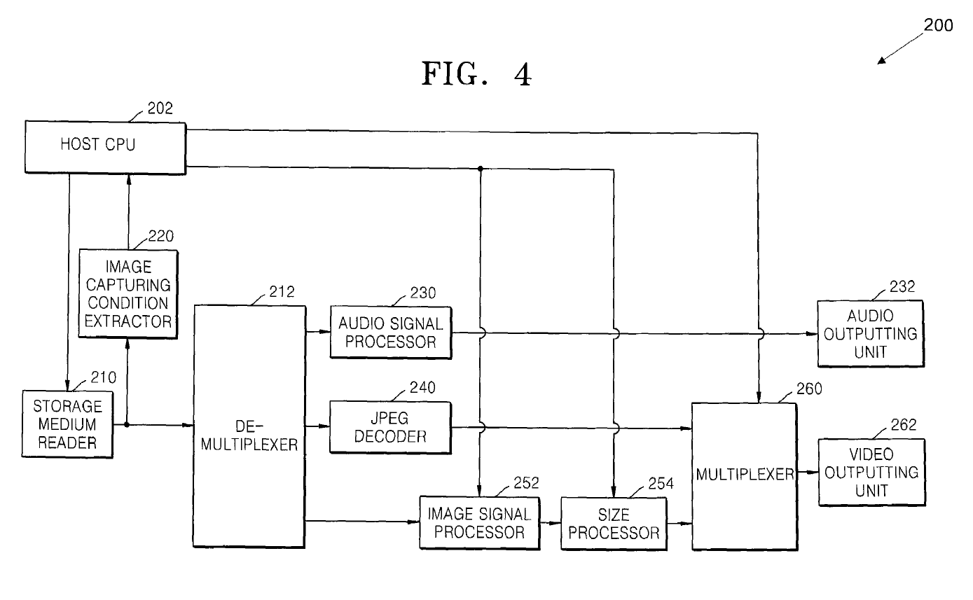

Next, a motion picture reproduction apparatus 200 reproducing motion picture data recorded in the motion picture recording apparatus 100 of FIG. 1 will be described in reference with FIG. 4. FIG. 4 is a block diagram illustrating an example of a configuration of the motion picture reproduction apparatus 200 according to an embodiment of the present invention. As shown in FIG. 4, the motion picture reproduction apparatus 200 includes a host CPU 202, a storage medium reader 210, a de-multiplexer 212, a image capturing condition extractor 220, an audio signal processor 230, an audio outputting unit 232, a JPEG decoder 240, an image signal processor 252, a size processor 254, a multiplexer (MUX) 260, and a video outputting unit 262. The storage medium reader 210 reads data from a storage medium according to an instruction from the host CPU 202.

The de-multiplexer 212 temporarily collects read data from the storage medium reader 210 and transmits the collected data to the audio signal processor 230, the JPEG decoder 240, and the image signal processor 252. The image capturing condition extractor 220 extracts image capturing condition data recorded in a frame header and transmits the image capturing condition data to the host CPU 202.

The host CPU 202 controls image processes such as an image process in the image signal processor 252 or the size processor 254 according to the image capturing condition data transmitted from the image capturing condition extractor 220. Therefore, in case where image capturing condition data is read from a storage medium, conditions for reading out pixel data from an imaging device are set according to the image capturing condition data. Then, image signal processes and sizing process are performed according to the conditions for reading out the pixel data. Thus, appropriate image processes can be performed according to raw data even if image capturing conditions and conditions for reading the pixel data from the imaging device are different from each other. The audio signal processor 230 deformats audio data, converts the deformatted signals from digital to analog, and transmits the converted signals to the audio outputting unit 232. The audio outputting unit 232 outputs the analog-converted audio signals. Furthermore, the JPEG decoder 240 decodes compressed image data, reduces or magnifies the decoded image data, and transmits the image data either reduced or magnified to the multiplexer 260. Also, the image signal processor 252 performs Bayer de-formatting on raw data, rearranges the raw data in the Bayer arrangement, and transmits the rearranged raw data to the size processor 254.

With respect to the deformatted raw data, the image signal processor 252 performs image signal processes such as a white balance process, a data interpolation process according to the Bayer arrangement, noise elimination, brightness and color correction, etc. The size processor 254 performs a process reducing the size of raw data on which image signal processes are performed and transmits the processed raw data to the MUX 260.

The MUX 260 transmits image data, which is transmitted from the JPEG decoder 240 or the size processor 254, to the video outputting unit 262. The video outputting unit 262 converts the transmitted data from digital to analog and outputs the analog-converted signal data. Furthermore, processes in the motion picture reproduction apparatus 200 can be performed either by hardware or software. In the motion picture reproduction apparatus 200 according to the current embodiment, the image signal process and the size process are performed by using image capturing condition data recorded in each of frame headers of a file read by the storage medium reader 210.

In addition, conditions for reading pixel data from an imaging device generally vary according to the configuration of the imaging device or an image capturing mode of the motion picture recording apparatus 100. However, according to the motion picture reproduction apparatus 200 according to the current embodiment, calculation for a pixel mixing process and calculation for a pixel cropping process can be performed when a pixel data reading process is being performed according to image capturing conditions. Thus, appropriate image processes according to resolution, frame rate, image quality, etc., can be performed based on raw data.

When raw data is reproduced, each of the raw data including G, B, and R are read from a storage medium. The raw data is changed to image signals by performing image signal processes on the read data. The signals are reduced to a predetermined image size and are output from the video outputting unit 262. Thus, high quality images can be reproduced by the motion picture reproduction apparatus 200.

When compressed image data is reproduced, the compressed image data can be reproduced by sequentially reading compressed image data from a storage medium per frame. In this case, the size of read data is significantly smaller than that of raw data. By reducing or magnifying JPEG-decoded image signals into a predetermined image size and outputting the image signals either reduced or magnified, compressed image data can be reproduced via low-load processes as compared to raw data reproduction. Accordingly, by using simplified reproduction mode using compressed image data, the hardware configuration of the motion picture reproduction apparatus 200 can be significantly simplified. Simultaneously, power consumption can be significantly lowered.

Also, in a high-speed reproduction mode, which is a special reproduction mode, a low-load process can be performed by using JPEG data. In this case, only frame headers can be browsed to determine reproduction speed, read compressed image data by performing interlaced scan on only required frames from data size information of audio data, compressed image data, and raw data, JPEG decodes the compressed image data, and read out the decoded data. The method can also be used in reverse reproduction. Furthermore, it is also possible to show an index of captured images in a file as thumbnail images by using compressed image data. In this case, with respect to each of a plurality of motion picture files, one frame image of each motion picture files can be shown as thumbnail image or the motion picture can be shown as thumbnail image.

As described hitherto, both raw data and compressed image data can be recorded by relating them to each other according to the current embodiment. Therefore, raw data is used for high quality reproduction, whereas compressed image data which has small size is used for real time display, image browsing, etc. Thus, the motion picture recording apparatus 100 and the motion picture reproduction apparatus 200 providing high image quality and excellent control-base interaction can be provided. According to the embodiments of the present invention discussed above, image process can be easily performed on raw data according to various image capturing modes when image is captured.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A recording apparatus comprising:
an image processor which processes an image into reproducible image data on raw data sequentially output from an imaging device in frames and generates reproducibly processed image data in frames;
an image capturing condition obtaining unit which obtains image capturing conditions per frame, which are required for reading pixel data from the imaging device and are set when the processed image data is being recorded; and
a storage medium recorder which sequentially records the raw data in frames, the processed image data in frames, and the image capturing condition in frames to a storage medium per frame.

2. The recording apparatus of claim 1, wherein the image capturing condition is a condition regarding pixel mixing process or pixel cropping process on each of pixels when pixel data is being read from the imaging device.

3. The recording apparatus of claim 1, further comprising:
an audio signal processor which processes audio data relating to the image data; and
wherein the storage medium recorder records the processed audio data to the storage medium.

4. The recording apparatus of claim 1, wherein:
image capturing conditions include at least one of a number of pixels of the imaging device, a pitch of the pixels, an image resolution, a frame rate, and a quality of an image.

5. A reproduction apparatus comprising:
a data reader which reads out at least one of each of raw data, each of processed image data, and each of image capturing condition from a storage medium having recorded thereon the raw data in frames, the reproducibly processed image data being in frames obtained by performing image processes into reproducible image data on the raw data, and the image capturing conditions per frame according to an image capturing mode being set when the processed image data is being recorded; and
an image processor which processes an image by reading each pixel data from an imaging device according to the read out image capturing condition when the raw data is sequentially reproduced per frame.

6. The reproduction apparatus of claim 5, wherein the read out image capturing condition is a condition regarding pixel mixing process or pixel cropping process on each of pixels when pixel data is being read from the imaging device.

7. The reproduction apparatus of claim 5, wherein the data reader further reads out audio data from the storage medium.

8. A recording method comprising:
processing image data into reproducible image data on raw data sequentially output from an imaging device in frames and generating processed image data in frames;
obtaining image capturing conditions per frame, which are required for reading pixel data from the imaging device and are set when the processed image data is being recorded; and
sequentially recording the raw data in frames, the processed image data in frames, and the image capturing conditions in frames to a storage medium per frame.

9. The recording method of claim 8, wherein the image capturing condition is a condition regarding pixel mixing process or pixel cropping process on each of pixels when pixel data is being read from the imaging device.

10. The recording method of claim 8, further comprising:
processing audio data relating to the image data; and
recording the audio signals to the storage medium.

11. The recording method of claim 8, wherein:
image capturing conditions include at least one of a number of pixels of the imaging device, a pitch of the pixels, an image resolution, a frame rate, and a quality of an image.

12. A reproducing method comprising:
reading out at least one of each of raw data, each of processed image data, and each of image capturing condition from a storage medium having recorded thereon the raw data in frames, the processed image data in frames being obtained by performing image processes into reproducible image data on the raw data, and the image capturing condition per frame according to an image capturing mode being set when the processed image data is being recorded; and
reading each pixel data from an imaging device according to the read out image capturing condition.

13. The reproduction method of claim 12, wherein the read out image capturing condition is a condition regarding pixel mixing process or pixel cropping process on each of pixels when pixel data is being read from the imaging device.

14. The reproduction method of claim 12, further comprising reading out audio data from the storage medium.

15. A storage medium having recorded thereon a computer program for executing a method, the method comprising:
processing an image into reproducible image data on raw data, sequentially output from an imaging device in frames and generating processed image data in frames;
obtaining image capturing conditions per frame, which are required for reading pixel data from the imaging device and are set when the processed image data is being recorded; and
sequentially recording the raw data in frames, the processed image data in frames, and the image capturing conditions in frames to a storage medium per frame.

16. The storage medium of claim 15, wherein the image capturing condition is a condition regarding pixel mixing process or pixel cropping process on each of pixels when pixel data is being read from the imaging device.

17. The storage medium of claim 15, wherein the method further comprises:
processing audio data relating to the image data; and
recording the processed audio data to the storage medium.

18. The storage medium of claim 15, wherein:
image capturing conditions include at least one of a number of pixels of the imaging device, a pitch of the pixels, an image resolution, a frame rate, and a quality of an image.

19. A storage medium having recorded thereon a computer program for executing a method, the method comprising:
reading out at least one of each of raw data, each of processed image data, and each of image capturing condition from a storage medium having recorded thereon the raw data in frames, the processed image data being in frames obtained by performing image processes into reproducible image data on the raw data, and the image capturing condition per frame according to an image capturing mode being set when the processed image data is being recorded; and
processing image data by reading each pixel data from an imaging device according to the read out image capturing condition.

20. The storage medium of claim 19, wherein the read out image capturing condition is a condition regarding pixel mixing process or pixel cropping process on each of pixels when pixel data is being read from the imaging device.

21. The reproduction method of claim 19, wherein the method further comprises reading out audio data from the storage medium.
